(19) United States
(12) Patent Application Publication
(10) Pub. No.: US 2007/0094113 A1
(43) Pub. Date: Apr. 26, 2007

(54) Transactional mobile system

(76) Inventor: Eduardo Chapeta, Cordoba (AR)

Correspondence Address: STEVEN L. SCHMID, 1824 HICKORY TRACE DRIVE, FLEMING ISLAND, FL, 32003, US

(21) Appl. No.: 11/256,635

(22) Filed: Oct. 21, 2005

(51) Int. Cl. G06Q 40/00

(52) U.S. Cl. 705/35

(57) ABSTRACT

Disclosed is a secure transactional mobile system having a central hub in communication with a wireless network and/or device such a mobile phone, wherein the central hub processes a transactional request from the wireless device for validating the request. The central hub may forwards the validated request to a transactional network for payment or process the request internally for payment or transaction. Once payment has been approved, the central hub my then signal the wireless device that such has been accepted.

### TECHNICAL FIELD

The present system relates to a method of purchasing goods and services and in greater detail the present system relates to a method of transferring money for payment of goods and services, both real and virtual, which are facilitated by the use a mobile device or wireless network.

### BACKGROUND

Sales transactions in today's economy can be done by a number of mechanisms, including in person with direct contact with a merchant selling goods and/or services (called herein a Point of Sales (POS) transaction), by using a telephone, by using the Internet, by using the mail, and even by using an interactive cable television system. In the context of this application, the term merchant includes any party selling or offering for sale an item of goods or services, and can include a business person or another individual. The sales are consummated by a payment mechanism that is either a payment by cash, check, credit card, debit card or pre-paid cards. If payment is done by check, credit card or debit card, then a payment system must be used which usually involves a clearance center (CC).

Most existing payment systems use a bank or other financial organization as the clearance center. Many sales establishments, which can include retail stores, telephone marketers, Internet web sites, or mail catalog centers, have business relationships with the clearance centers whereby the sales establishments can accept payments for the merchandise or services by a check, credit or debit card. In some personal point of service locations there are direct communication links with the clearance center. Usually these links are by dedicated telephone lines which connect, for example, an establishment's Point Of Sale or POS device that is a dedicated piece of hardware equipment and can include a sales establishment's keypad, a customer's keypad, or a card reader which can be combined with one of the foregoing or can be a separate piece of equipment.

Security is always of paramount importance in any point of sales transactions. Usually the security is in the form of a password, or Personal Identification Number (PIN), that only the customer or user of the payment mechanism knows. Naturally, the use of such passwords has numerous problems that include the user forgetting the password, the hardware equipment being faulty, or a compromise in the password. In the conventional systems in use today, there is also no mechanism or system to validate that the user of the password is who he or she says. The user simply enters the password and if correct, the transaction proceeds.

Presently, payment via credit card typically is limited to fixed locations, such as department stores, restaurants, etc. This limitation presents a problem for the merchant who is highly mobile, such as a taxi driver or a merchant who does business in an outdoor market, for example. Mobile solutions have not been cost effective since they involve spectrum utilization, which can be very costly. Additionally, present mobile solutions depend on the deployment of a wireless network for operations, adding further cost to the mobile solution.

Accordingly, it would be advantageous to provide a payment system that allows for a mobile merchant as well as a fixed location merchant to accept payment via credit card, debit card or pre-paid cards. Therefore, there is a need in the art for a payment system that provides a secure environment for the transmission of financial information and is highly mobile. Additionally, it would be advantageous to provide a payment system that has minimal startup costs for the end user.

### SUMMARY

The present system includes a transactional mobile system having a central hub in communication with a wireless network. The central hub process a transactional request that may be acquired from the wireless network for validating the request. The central hub further processes the validated request for payment or transaction. The central hub may then signal a user upon approval of such payment or transaction.

In a further embodiment, the transactional mobile services system may include a control hub connected to the internet, mobile phone network and a transactional network.

Transactions occur through a customer accessing the control hub through a mobile device. The control hub processes transactional requests and validates such requests against a database and then if needed the request is then forwarded to a transaction network for processing the payment. The system can be originated by a consumer, merchant or business, a third party or act as a Point Of Sale (POS) system.

An additional embodiment includes a system having a central hub in communication with a wireless device and/or wireless network, wherein the central hub processes a transactional request from the wireless device for validating the request. The central hub may then forwards the validated request to a transactional network for payment. Once payment has been approved, the central hub my then signal the wireless device that such has been accepted.

A further embodiment includes a transactional mobile system comprises a central hub in communication with a mobile device and/or network wherein the central hub acquires a caller ID from the mobile phone along with the transactional request from the mobile phone. The central hub then validates the transactional request with a known database stored or accessed by the central hub. The validated request may then be forwarded to a transactional network for payment and the mobile phone is signaled once the payment has been approved.

In the business originated embodiment the transactional mobile system includes a transaction identifier being forwarded to the mobile phone of the consumer along with a transaction confirmation request. The merchant or business also designates a longevity time period in which the consumer may replay to the request. If the consumer does not respond to the request in the time period, the control hub sends a signal to all parties that the transaction has expired and is now void. It is also contemplated that the present system may also be accesses by a third party who would act in a similar manner as that of the business originated embodiment.

An additional embodiment includes a system having a central hub in communication with a mobile device or phone and acquiring a caller ID or other call identification from the mobile phone along with the transactional request. The transactional request comprises data selected from the group of a price quotient, product/service code, business identification and/or customer identification. The central hub validates the transactional request by comparing the data to that contained in a known database comprised of user information. The validated request is then forwarded for payment and the mobile phone is then notified of such.

### DRAWINGS

In the drawings:

FIG. 1 is an overview flow diagram of the present method and system;

FIG. 2 is a block flow diagram illustrating the consumer originated embodiment of the present system; and

FIG. 3 is a block flow diagram depicting the Point Of Sale embodiment of the present system.

### DETAILED DESCRIPTION

The present system includes a transactional mobile system having a central hub. The term “central hub” is used herein to mean any program or computer performing the functions described within the present specification. For example, the central hub may be embodied in one or more computers or servers wherein the central hub is in communication a wireless network(s) and/or various wireless devices. The central hub may use any type of signaling device and/or interface for communicating. The system is designed to provide secure electronic transactions in an easy to use system for both merchants and consumers. Typically, the wireless device is a mobile phone but other such devices are contemplated such as PDAs, smart phones, notebooks or other devices that can access a mobile phone network, wireless network and/or WiFi network. A wireless network may include the Internet.

Security and verification can be accomplished by various means in the present system. Primarily, the user is identified and confirmed by a caller ID when the user contacts the central hub via a mobile phone. Furthermore, the user may be identified by other means which carry the identity of the caller or user of a mobile device. Additional security measures may be taken such as prompting the user for a password or a PIN number. The user is further issued an identification by which the central hub further recognizes the user. Typically, this identification is in the form of a number. Merchants or businesses are given a business number and consumers or customers are given a customer number. A merchant would identify a customer by their number to the central hub and a customer would identify the business to the control hub by the business's number.

The central hub comprises a database wherein the information of each user is stored and cross referenced to determine verification when a user accesses the central hub. Users may be identified by caller ID or other mobile device user identification when a user accesses the central hub. A user may further be prompted for a password or PIN number if additional security is desired. Various means of interface with the central hub may be used. For example most any known method may be used such as pure SMS, IVR, Wap, Internet, email or Java using internally SMS or Internet access by use of wireless “mobile” data such as GPRS, EDGE and/or the like.

The central hub can further be connected to a transaction network to authorize payment or a transactional equivalent once verification has been accomplished. Such transaction networks may include by way of example Visa, MasterCard, Amex, ATM, bank accounts, service company bills, electronic money and/or a proprietary system. Example existing ATM/credit card infrastructures include standard computer data processing telecommunications networks for transmitting authorization requests is the VISA. RTM. credit transaction network. In addition to VISA. RTM. credit cards, merchants connected to this network may seek authorization for approval of transactions involving other credit cards, such as MASTER CARD. RTM. and DISCOVER. RTM. credit or debits cards. The VISA. RTM. credit transaction network includes a plurality of data processors and financial institutions, all interconnected through telecommunication links which, based on a six digit bank identification number (BIN), route all authorization requests to the appropriate card-issuer and all authorization responses back to the requesting authority.

Additionally, the central hub may act as a full transactional system without the need to contract an outside transactional network. The central hub may perform essentially the same function as the transactional network in that the central hub may have accounts created directly within the central hub. A user's credit line or balance in an account resides directly within the central hub and not with an outside transactional network. Thus, accounts residing within the central hub do not require the central hub to contact a transactional network for payment processing since such can be done by the central hub.

Furthermore, the central hub records and stores each transaction. Both externally and internally transactions are stored with the information being retrievable by an authorized user. The central hub further has a transparent mechanism which allows the users to consult and manages their various accounts, movements, audit logs and rights in a real time basis.

Once payment has been approved by the transaction network, the central hub my then signal the wireless device that the transaction has been accepted. The central hub may contact both parties confirming the approval along with providing a transaction identifier, such as a transaction number. Notification is typically sent to the user's mobile device but may be sent by other means.

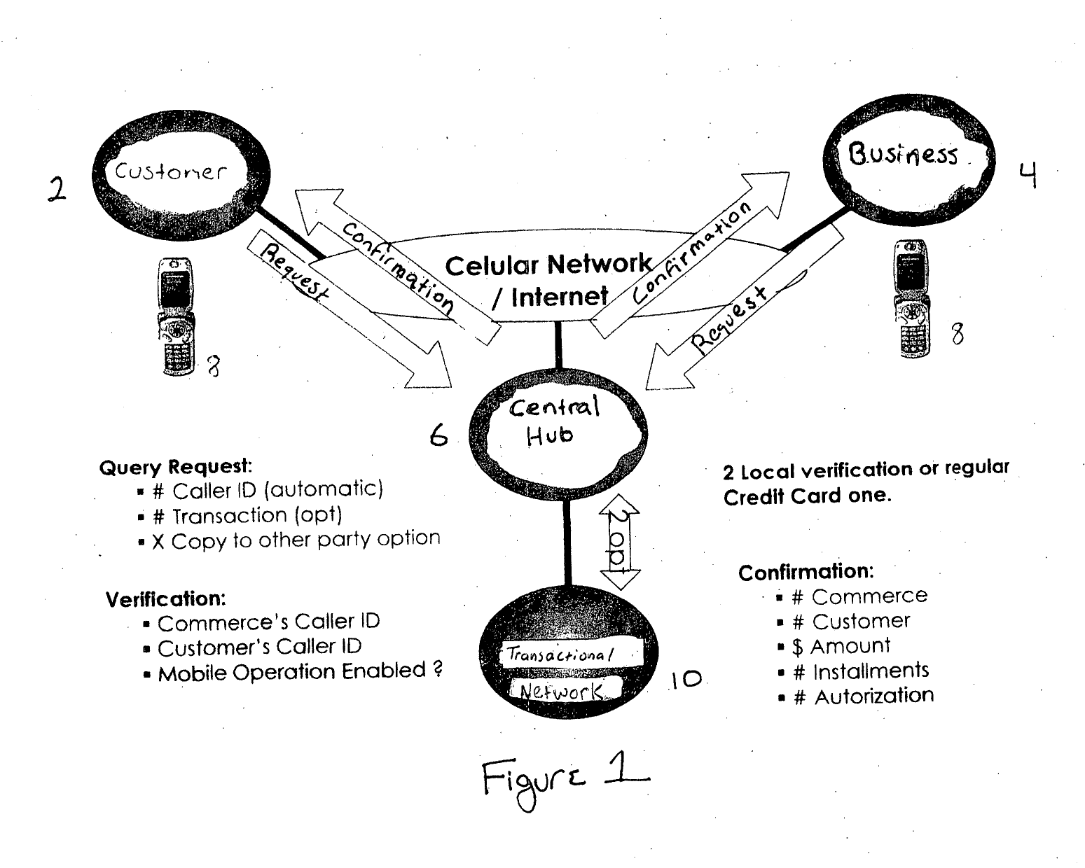

Turning now to the attached drawings, wherein like reference numerals will refer to like elements throughout, FIG. 1 represents an overall view of the present system. The customer 2 sends and receives signals from a mobile phone 8 to the central hub 6. The business 4 or merchant sends and receives signals to the central hub 6 from a mobile phone 8. The query request or transactional request includes a caller ID and may include a transaction number and copy of the request to the other party. The transaction request may also include a price quotient. The central hub 6 verifies the users' caller IDs and contacts the transactional network for payment authorization. Additionally, a business can use the system in a Point-Of-Sale (PSO) mode wherein the customer directly accesses the merchant and the merchant accesses the central hub via a mobile phone.

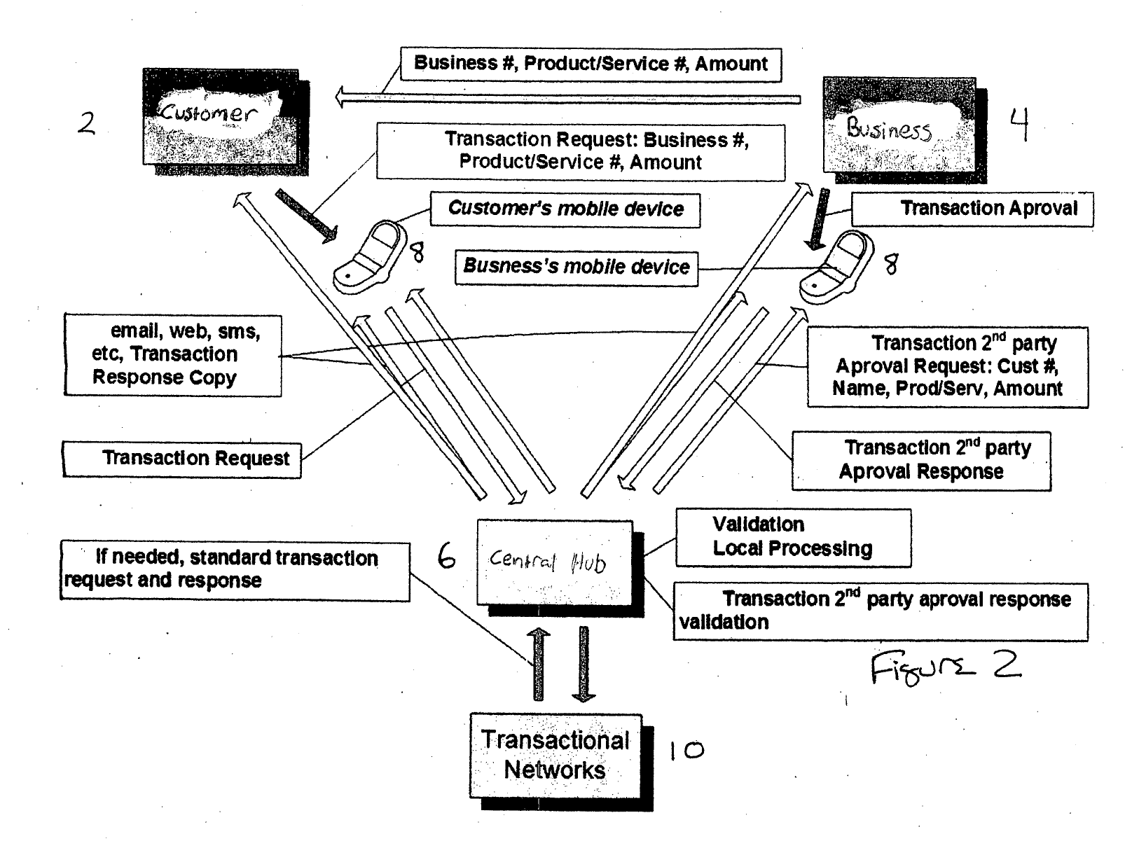

FIG. 2 illustrates the customer originated transactional mobile service system. In this embodiment the customer 2 receives a business number or identification along with a product/service code for an item or service that the customer 2 wishes to receive. Such a publication can be through any known advising medium or communication such as advertisement on a magazine, newspaper or web page, email, SMS, MMS email and like. Additionally the price of the goods or services is listed. The customer 2 transmits a transactional request to the central hub 6 via a wireless device or mobile phone 8. The central hub acknowledges the customer's 2 caller ID and verifies the transactional request which includes verifying both customer and business identifications, the caller ID, operational status and amount limits. Once verified, the information is forwarded to a transactional network 10 for payments. If the operation is approved by the network 10, the central hub 6 sends a confirmation message to both parties along with a unique traction identifier.

The customer 2 may acquire a business number, product service number and price for the service or goods through various methods from a business 4. The customer 2 may then through a mobile device 8 submit a transaction request to the central hub 6. The central hub may validate the request, approve the request locally and/or send the validated request to a transactional network 10 for payment approval. Additionally, the central hub 6 may validate a second party approval response. The business 4 may approve the transactional request using a mobile device 8 and contacting the central hub 6 after the central hub contacts the business with a second party approval request which may include a customer name, product or service and the amount. Additionally, a transaction response copy may be sent to the parties.

Furthermore, in a further embodiment, the business 4 may send a transactional request to the central hub 6 that may include a longevity field. The longevity field specifies how long the offer remains open for the customer 2 to accept. The central hub 6 then validates the transactional request sends a transaction confirmation request to the customer 2 along with a unique transaction identifier. To accept the request, the customer 2 must approve the request within the time period set by the longevity time period. Once accepted, the central hub validates the information and forwards the request to the transactional network 10 for payment. Additionally, the central hub 6 my process the validated request internally for payment or transactional approval. If the request is accepted for payment the central hub sends a confirmation message to both parties. If the longevity period expires without the customer 2 having accepted the confirmation request, the offer expires and a message voiding the transaction is sent both parties.

The central hub 6 may further provide a post approval phase wherein the customer 2 notifies the central hub 6 regarding the customer's satisfaction with the transaction and the good and services received. The goods and services include both virtual and real items. Virtual items include by example and not limitation, music, news video, wallpapers and ring tones.

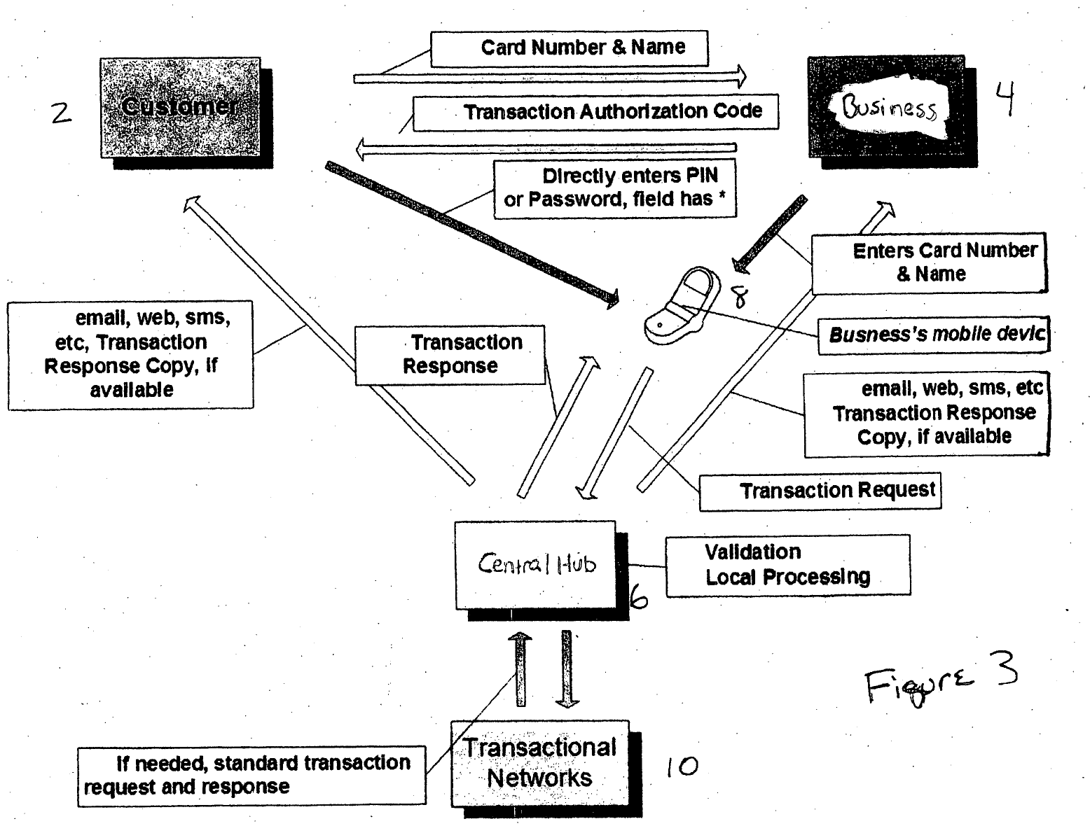

FIG. 3 illustrates the Point Of Sale (POS) mode or business originated transactional mobile service system. In this embodiment the business 4 receives a request for a product or service from a customer 2. The request can come from any means, for example but not by limitation, physical presence, phone call, email and the like. The transactional request can include such information as customer identification, product/service code and cost of the item.

Furthermore, in the POS mode the customer 2 may transmit to the business 4 the card number and name of the customer 2. The business 4 may then enter the card and name information into the business mobile device 8. The customer then may further enter their PIN number and/or password into a field on the business mobile device 8. The transaction request is then sent to the central hub 6 for validation and/or payment which may be done internally or through a transactional network 10. A confirmation or transformation response copy may then be sent to the parties through most any means including email, web, sms and the like.

Additionally, the system may be third party originated. The third party originated system includes a third party generating a transaction request that involves a business 4 and a customer 2. At this point, the method moves essentially the same as the business originated system except that the third also receives the notifications.

While applicants have set forth embodiments as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A transactional mobile system comprising:
a central hub in communication with a wireless network wherein the central hub processes a transactional request for validating the request;
the central hub further processing the validated request for payment; and
the central hub signaling a user upon approval of the payment.

2. The transactional mobile system of claim 1, further including the central hub signaling the user upon the initiation and/or completion of a transaction.

3. The transactional mobile system of claim 1, further including the central hub acquiring the identity of the user.

4. The transactional mobile system of claim 3, wherein the acquired identity includes a caller ID.

5. The transactional mobile system of claim 1, wherein the step of the central hub processing the validated request for payment includes the central hub forwarding the validated request to a transactional network for payment.

6. The transactional mobile system of claim 1, further including a first and second user, wherein the first user initiates the transaction request and the second user approves the transaction request.

7. The transaction mobile system of claim 1, wherein the use notifies the central hub as to the completeness of a transaction.

8. The transactional mobile system of claim 1, wherein the central hub communicates with the wireless network via a wireless device.

9. The transaction mobile system of claim 8, wherein the wireless device is selected from the group consisting essentially of a mobile phone, PDA, notebook and a smart phone.

10. The transactional mobile system of claim 1, wherein the step of the central hub further processing the validated request for payment includes authorizing payment from an internal account held on the central hub.

11. A transactional mobile system comprising:
a central hub in communication with a wireless device wherein the central hub processes a transactional request from the wireless device for validating the request;
the central hub forwarding the validated request to a transactional network for payment; and
the central hub signaling a user upon approval of the payment by the transactional network.

12. The transactional mobile system of claim 11, wherein the wireless device is a mobile phone.

13. The transactional mobile system of claim 11, wherein the transactional request includes a business identification and product/service code.

14. The transactional mobile system of claim 13, wherein the transactional request further includes a price quotient.

15. The transactional mobile system of claim 11, wherein the transactional request includes a customer identification.

16. The transactional mobile system of claim 11, wherein the central hub validates the request by cross referencing the transactional request with a known database.

17. The transactional mobile system of claim 11, further including a plurality of wireless devices being signaled upon approval of the payment by the transactional network.

18. A transactional mobile system comprising:
a central hub in communication with a mobile device, the central hub acquiring a caller ID from the mobile phone and receiving a transactional request from the mobile phone;
the central hub validating the transactional request;
the central hub forwarding the validated request to a transactional network for payment; and
the central hub signaling the mobile device upon approval of the payment by the transactional network.

19. The transactional mobile system of claim 18, wherein the transactional request includes transactional data selected from a price quotient, product/service code, business identification and/or customer identification.

20. The transactional mobile system of claim 19, wherein the transactional data is verified with a known database by the central hub.

21. The transactional mobile system of claim 18, wherein the mobile device is a mobile phone and transaction identifier is forwarded to the mobile phone by the central hub.

22. The transactional mobile system of claim 18, further including the central hub receiving a customer reply approving the transaction.

23. The transactional mobile system of claim 22, wherein the customer reply is received within a longevity time period.

24. The transactional mobile system of claim 18, further including a void notice sent to the mobile device if a customer reply is not received with a longevity time period.

25. The transactional mobile system of claim 18, further including a plurality of mobile devices being signaled by the central hub.

26. The transactional mobile system of claim 25, wherein the plurality of mobile devices include a customer phone, business phone and a third party phone.

27. The transactional mobile system of claim 18, wherein the central hub is in communication with a mobile phone network, internet and transactional network.

28. A transactional mobile system comprising:
a central hub in communication with a mobile phone, the central hub acquiring a caller ID from the mobile phone and receiving a transactional request from the mobile phone;
the transactional request comprising data selected from the group of a price quotient, product/service code, business identification and/or customer identification;
the central hub validating the transactional request by comparing the data to that contained in a known database of user information;
the central hub forwarding the validated request to a transactional network for payment; and
the central hub signaling the mobile phone upon approval of the payment by the transactional network.

29. The transactional mobile system of claim 28, further including the central hub receiving a customer reply approving the transaction.

30. The transactional mobile system of claim 28, wherein the customer reply is received within a longevity time period.
